(19) United States
(12) Patent Application Publication
(10) Pub. No.: US 2023/0003291 A1
(43) Pub. Date: Jan. 5, 2023

(54) COMPLIANT ANTI-BACKLASH GEAR

(71) Applicant: Optisys, Inc., West Jordan, UT (US)

(72) Inventors: Robert Smith, West Jordan, UT (US); Daniel Ricks, West Jordan, UT (US); Jacob Morrise, West Jordan, UT (US)

(73) Assignee: Optisys, Inc., West Jordan, UT (US)

(21) Appl. No.: 17/810,016

(22) Filed: Jun. 30, 2022

Related U.S. Application Data
(60) Provisional application No. 63/216,930, filed on Jun. 30, 2021.

(51) Int. Cl. F16H 55/18

(52) U.S. Cl. CPC F16H 55/18

(57) ABSTRACT

Anti-backlash gears and anti-backlash gear systems. A gear includes a plurality of compliant members extending outward to form at least a portion of the gear. The gear is such that each of the plurality of compliant members is configured to elastically deform when exposed to an applied force

### CROSS-REFERENCE TO RELATED APPLICATIONS

This application claims the benefit of U.S. Provisional Patent Application No. 63/216,930, entitled “COMPLIANT ANTI-BACKLASH GEAR,” which is incorporated herein by reference in its entirety, including but not limited to those portions that specifically appear hereinafter, the incorporation by reference being made with the following exception: In the event that any portion of the above-referenced provisional application is inconsistent with this application, this application supersedes the above-referenced provisional application.

### TECHNICAL FIELD

The disclosure relates to gears and gear systems and relates specifically to anti-backlash gears configured to reduce or eliminate backlash.

### BACKGROUND

Backlash is a known problem associated with gears and gear systems. Backlash is problematic in systems that change direction (e.g., a gear is driven to change directions and rotate in both clockwise and counterclockwise directions), and systems that require movement with a high degree of precision. In some implementations, it is important to ensure that gears can change rotational direction and stop rotating at a stable position with a high degree of precision. One example implementation is an antenna array system, wherein a scanning antenna array is positioned in real-time based on a received input to ensure the antenna array is pointed in the correct direction for receiving and/or transmitting electromagnetic signals.

Backlash is sometimes referred to as lash, play, or slop. Backlash in a gear system results from clearance between the teeth of two gears. This is sometimes described as lost motion in a mechanism driven by the gear system due to the gaps/clearance in between the teeth of two gears. Backlash occurs when a first gear rotates in one direction, through a certain angle or distance corresponding to the backlash clearance, without the teeth of the first gear meeting and/or applying force or movement to the teeth of the second gear.

Backlash in mechanical systems results in mechanical and energy losses in the operation of the system. In other words, backlash causes electrical and mechanical energy to be expended without translating into movement or drive in the mechanical system. In systems in which backlash is undesirable, this may cause unpredictable positioning of shafts and gears, as well as unpredictable operation of the mechanical system.

In certain applications, positioning of gears and shafts is important for computational and feedback purposes. For example, in antenna positioning and communications machinery, it may be important to determine an angular position of the antenna with respect to other elements of machinery in the system or elements outside of the machinery. Other applications such as weaponry, satellite communications, optical systems, etc. may also rely on accurate positioning or positioning data of various parts of machinery such as gears, shafts, and other elements.

Current designs of the anti-backlash gears include multiple gears, multiple springs, and multiple connection points where the springs are connected to both gears. Accordingly, the traditional anti-backlash gears are manufactured in separate pieces in multiple steps and are then assembled to form a complete anti-backlash gear. Because of the multiple parts and pieces, traditional anti-backlash gears are more complex, more difficult to install, and use more energy, processes, create re-installation and maintenance challenges, and power then are necessary or desirable. As such, a current need exists for anti-backlash gears that are less complex, easier to use, contain fewer parts, and are easier and more efficient to manufacture and implement.

It is therefore one object of this disclosure to provide anti-backlash gears that are simpler, more efficient to manufacture, and easier to implement than traditional anti-backlash gears. It is further an object of this disclosure to provide alternative anti-backlash gears that prevent or reduce backlash in mechanical systems. It is a further object of this disclosure to provide anti-backlash gears that may be manufactured more simply than traditional anti-backlash gears, including anti-backlash gears that may be manufactured as a single indivisible element in a single manufacturing process, such as, for example, three-dimensional printing processes (e.g., additive manufacturing processes) or others.

### BRIEF DESCRIPTION OF THE DRAWINGS

Non-limiting and non-exhaustive implementations of the present disclosure are described with reference to the following figures, wherein like reference numerals refer to like parts throughout the various views unless otherwise specified. Advantages of the present disclosure will become better understood regarding the following description and accompanying drawings where:

FIG. 1A illustrates a front view of an exemplary gear system including two gears mated together to interface with each other, in which backlash is present in the exemplary gear system;

FIG. 1B illustrates a zoomed-in view of the exemplary gear system illustrated in FIG. 1A;

FIG. 2A illustrates a front view of a traditional anti-backlash gear where two gears of the anti-backlash gear are directly superimposed on each other;

FIG. 2B illustrates a side view of the traditional anti-backlash gear illustrated in FIG. 2A;

FIG. 2C illustrates a front view of the traditional anti-backlash gear illustrated in FIG. 2A, where the two gears of the traditional anti-backlash gear are turned in opposite directions such that the teeth of a second gear disposed behind a first gear are visible through gaps in between the teeth of a first gear disposed in front of the second gear;

FIG. 3 illustrates a front view of an exemplary gear system including a gear and the traditional anti-backlash gear of FIG. 2A mated together to interface with each other;

FIG. 4A illustrates a front view of an anti-backlash gear according to at least one embodiment of the disclosure;

FIG. 4B illustrates a perspective view of an anti-backlash gear according to at least one embodiment of the disclosure;

FIG. 4C illustrates a side view of an anti-backlash gear according to at least one embodiment of the disclosure;

FIG. 4D illustrates a partial view of an anti-backlash gear according to at least one embodiment of the disclosure;

FIG. 5 illustrates a partial view of an anti-backlash gear according to at least one embodiment of the disclosure in which a tooth of another gear is being engaged with compliant teeth of the anti-backlash gear;

FIG. 6 illustrates a front view of an anti-backlash gear according to at least one embodiment of the present disclosure being engaged with another gear;

FIG. 7 illustrates a front view of an anti-backlash gear according to at least one embodiment of the disclosure;

FIG. 8 illustrates a front view of an anti-backlash gear system that includes a mating gear and an anti-backlash gear according to at least one embodiment of the disclosure; and

FIG. 9 illustrates a front view of an anti-backlash gear system that includes a linear mating gear and an anti-backlash gear according to at least one embodiment of the disclosure.

### DETAILED DESCRIPTION

Disclosed herein are anti-backlash gears that reduce or prevent backlash as well as the effects and problems caused by backlash, which may be present in mechanical systems that utilize gears. The anti-backlash gears of the present disclosure are simpler and contain fewer parts than traditional anti-backlash gears. In some cases, the anti-backlash gears of the present disclosure are manufactured in a single process as a single indivisible element, thereby greatly simplifying the anti-backlash gears. The anti-backlash gears described herein are simpler to manufacture, install, and implement than traditional anti-backlash gear.

A gear described herein includes a central hub comprising a central hole disposed therethrough a plurality of compliant members attached to the central hub and extending radially outward relative to the central hole. The gear is such that each of the plurality of compliant members is configured to elastically deform when exposed to an applied force.

A gear system described herein includes an anti-backlash gear and a mating gear. The anti-backlash gear includes a central hub comprising a central hole disposed therethrough and a plurality of compliant members attached to the central hub and extending radially outward relative to the central hole. The anti-backlash gear is such that each of the plurality of compliant members is configured to elastically deform when exposed to an applied force. The mating gear comprises a plurality of teeth configured to interface with two or more of the plurality of compliant members of the anti-backlash gear.

The anti-backlash gears described herein are particularly beneficial in cases wherein a gear changes directions during use, and specifically when the gear must be driven with precise movements. An example use-case for the anti-backlash gears described herein is finely tuned antenna movements, for example, when an antenna array is electronically scanned back and forth to receive or transmit electromagnetic signals. In this use-case, the gears that move the antenna array back and forth must be capable of moving in either direction and must be capable of moving with precision to ensure the antenna array is pointed in the desired direction. The anti-backlash gears described herein are best suited to cases when the torsional load is relatively small.

The anti-backlash gears described herein include a plurality of compliant teeth that are each formed from two or more compliant members. The compliant members extend radially outward relative to a central hole disposed through a central hub. The compliant members are “compliant” such that they are flexible and elastic. The compliant members are fabricated of a material configured to deform or displace when exposed to an applied force, and then return to an equilibrium position when the applied force is removed.

The compliant members of the anti-backlash gear may be displaced by a tooth of another gear (may be referred to as a mating gear herein) engaged with the anti-backlash gear of the present disclosure. The tooth of the other gear may enter between compliant members of the compliant teeth of the anti-backlash gear and may displace/deform the compliant members apart to accommodate the tooth of the other gear. The “compliant” or elastic nature of the compliant members cause the compliant members to pinch and exert a force on both sides of the tooth of the mating gear. This reduces or eliminates backlash in the system.

The anti-backlash gear may be manufactured by any known machining/manufacturing methods and techniques such as casting, molding, cutting, three-dimensional printing (aka additive manufacturing), etc., and any combination of the foregoing. In various embodiments, the anti-backlash gear may be manufactured in metal, printed in metal, or any other material with sufficient strength to withstand loads experienced by the anti-backlash gear. In certain embodiments, the whole anti-backlash gear is manufactured in a single manufacturing process as a single indivisible element.

The anti-backlash gears according to embodiments described herein are useful for any application in which backlash is undesirable or unacceptable and should be reduced or eliminated. Embodiments of the anti-backlash gears described herein may be particularly useful in applications where determining angular position of gears and/or shafts attached to the gears is important.

In the following description, for purposes of explanation and not limitation, specific techniques and embodiments are set forth, such as particular techniques and configurations, to provide a thorough understanding of the device disclosed herein. While the techniques and embodiments will primarily be described in context with the accompanying drawings, those skilled in the art will further appreciate that the techniques and embodiments may also be practiced in other similar devices.

Reference will now be made in detail to the exemplary embodiments, examples of which are illustrated in the accompanying drawings. Wherever possible, the same reference numbers are used throughout the drawings to refer to the same or like parts. It is further noted that elements disclosed with respect to embodiments are not restricted to only those embodiments in which they are described. For example, an element described in reference to one embodiment or figure, may be alternatively included in another embodiment or figure regardless of whether those elements are shown or described in another embodiment or figure. In other words, elements in the figures may be interchangeable between various embodiments disclosed herein, whether shown or not.

Before the structure, systems, and methods of the anti-backlash gears are disclosed and described, it is to be understood that this disclosure is not limited to the structures, configurations, process steps, and materials disclosed herein as such structures, configurations, process steps, and materials may vary. It is also to be understood that the terminology employed herein is used for the purpose of describing embodiments only and is not intended to be limiting since the scope of the disclosure will be limited only by the appended claims and equivalents thereof.

In describing and claiming the subject matter of the disclosure, the following terminology will be used in accordance with the definitions set out below.

It must be noted that, as used in this specification and the appended claims, the singular forms “a,” “an,” and “the” include plural referents unless the context clearly dictates otherwise.

As used herein, the terms “comprising,” “including,” “containing,” “characterized by,” and grammatical equivalents thereof are inclusive or open-ended terms that do not exclude additional, unrecited elements or method steps.

As used herein, the phrase “consisting of” and grammatical equivalents thereof exclude any element or step not specified in the claim.

As used herein, the phrase “consisting essentially of” and grammatical equivalents thereof limit the scope of a claim to the specified materials or steps and those that do not materially affect the basic and novel characteristic or characteristics of the claimed disclosure.

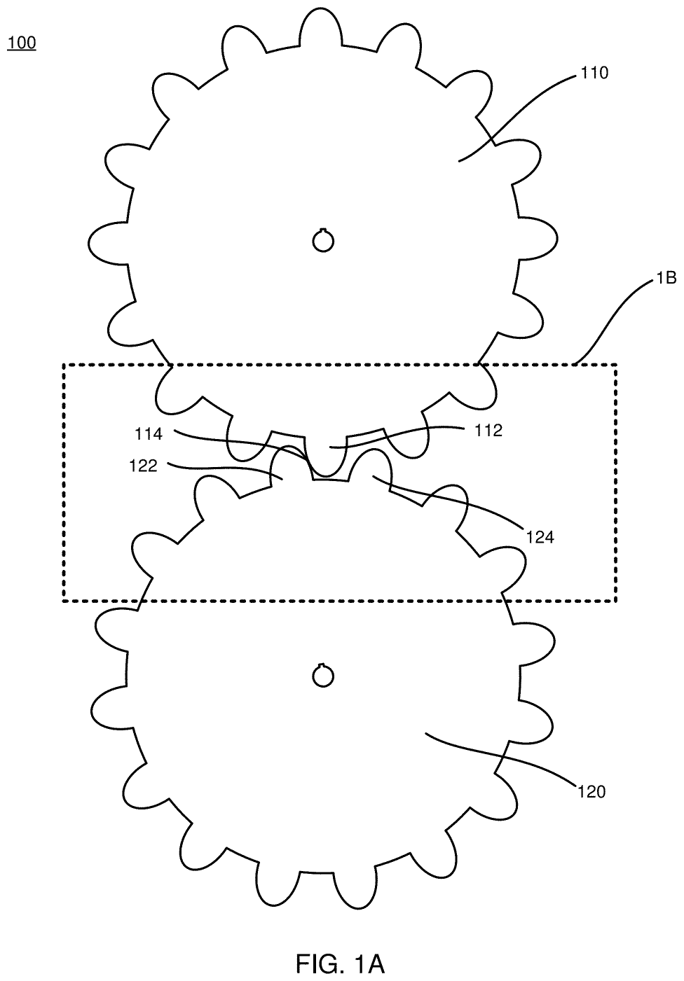

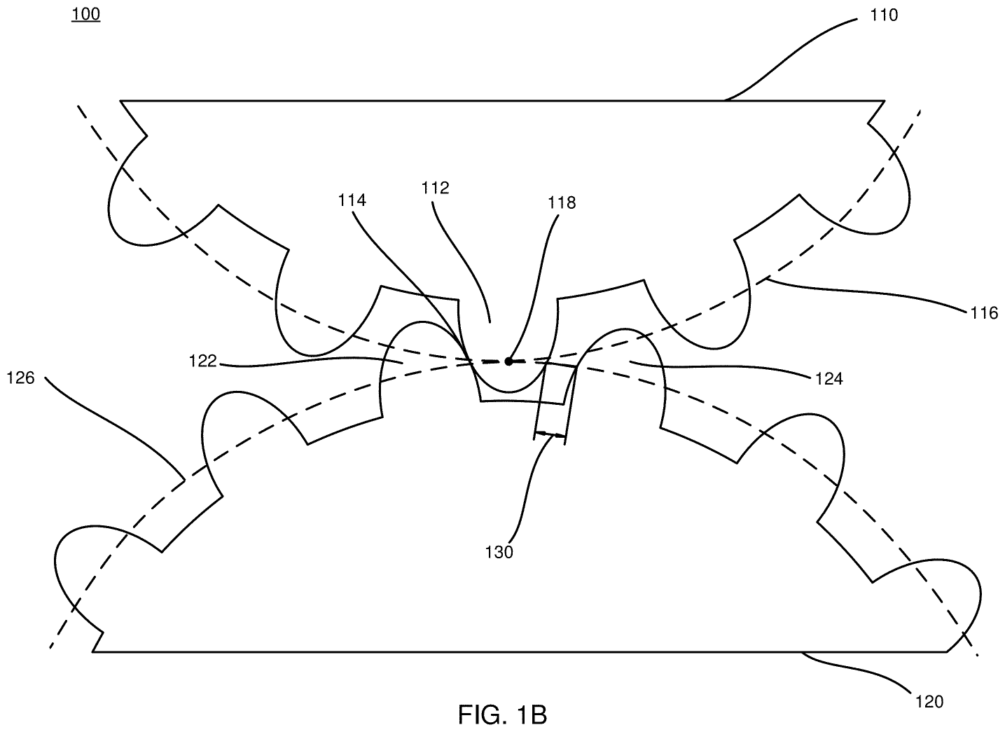

Before describing exemplary embodiments of the present application, this disclosure illustrates the problem of backlash with reference to FIGS. lA and 1B. FIG. 1A illustrates a front view of an exemplary gear system 100 including two gears engaged with and interfaced together to interface with each other. The gear system 100 includes a first gear 110 and a second gear 120. As shown, the first gear 110 and the second gear 120 interface with each other such that a tooth 112 of the first gear 110 is disposed between a first tooth 122 and a second tooth 124 of the second gear 120. As shown in FIG. 1A, the first tooth 122 of the second gear 120 contacts the tooth 112 of the first gear 110 at a contact point 114. However, when the first tooth 122 of the second gear 120 is in contact with the tooth 112 of the first gear 110, the second tooth 124 of the second gear 120 may not be in contact with the tooth 112 of first gear, thus leaving a gap between mating elements of the first gear 110 and the second gear 120 (i.e.., the tooth 112 of the first gear 110 and the second tooth 124 of the second gear 120). Backlash is more clearly shown in and described with reference to FIG. 1B.

FIG. 1B illustrates a zoomed-in view of the exemplary gear system 100 illustrated in FIG. 1A. Specifically, FIG. 1B illustrates a zoomed-in view of Section 1B of FIG. 1A. FIG. 1B illustrates the gear system 100 including the first gear 110 and the second gear 120. As shown, the first gear 110 and the second gear 120 engage with each other such that the tooth 112 of the first gear 110 is disposed between the first tooth 122 and the second tooth 124 of the second gear 120.

The pitch circle of each of the gears 110, 120 is shown when the first gear 110 and the second gear 120 engage with each other. The pitch circle of a gear is an imaginary circle that is tangential to a corresponding pitch circle of another gear engaged with the gear. In other words, the pitch circles are imaginary lines that model the gears as smooth rolling surfaces contacting each other. The first gear 110 has a first pitch circle 116 and the second gear 120 has a second pitch circle 126. The pitch circles 116, 126 meet at pitch point 118.

As shown, when the first gear 110 and the second gear 120 engage with one another such that their respective pitch circles 116, 126 are tangential to one another, the first tooth 122 of the second gear 120 contacts the tooth 112 of the first gear 110 at a contact point 114. However, the tooth 112 of the first gear 110 does not contact the second tooth 124 of the second gear 120 at the same time. Thus, there is a gap between mating elements, i.e.., the tooth 112 of the first gear and the second tooth 124 of the second gear 120.

The gap left between the tooth 112 of the first gear and the second tooth 124 of the second gear is backlash 130 of the gear system 100. The backlash 130 represents space between mating components of the gear system 100. As illustrated in FIG. 1B, the backlash 130 may cause lost motion in the gear system 100 before movement of the first gear 110 allows the tooth 112 to contact the second tooth 124 of the second gear 120.

For example, if the first gear 110 were to rotate in a counterclockwise direction in FIG. 1B, the tooth 112 of the first gear 110 must traverse the space between the tooth 112 of the first gear 110 and the second tooth 124 of the second gear 120 (i.e., backlash 130) before encountering the second tooth 124 of the second gear. Similarly, when the first gear 110 rotates such that the tooth 112 of the first gear 110 contacts the second tooth 124 of the second gear 120, a gap (backlash) is formed between the tooth 112 of the first gear and the first tooth 122 of the second gear. Therefore, if the first gear 110 were to change direction and rotate in a clockwise direction, then there would be lost motion cause by the backlash formed between the tooth 112 of the first gear 110 and the first tooth 122 of the second gear 120.

The lost motion caused by the backlash 130 causes mechanical and energy losses in the gear system 100. In other words, energy is spent to move the first gear 110, but that energy does not translate into power transfer or movement of the second gear 120 until the tooth 112 of the first gear 110 contacts the second tooth 124 of the second gear 120. This lost motion and backlash is undesirable in many gear systems.

Backlash is particularly undesirable in gear applications that utilize precise positioning of gears and/or shafts to perform operations and calculations and to perform positioning adjustments. The backlash 130 introduces an unknown element to the positioning of first gear 110, the second gear 120, and any shafts attached to the gears 110, 120. For example, the backlash 130 makes it difficult to know exactly how the first gear 110 and the second gear 120 are positioned with respect to each other. For example, at a stopping point of the gear system, the tooth 112 of the first gear 110 may be in contact with the first tooth 122 or the second tooth 124 of the second gear 120 or may be positioned somewhere in between. It is difficult to precisely determine or control the positioning of the gears 110, 120 when the placement of the gears 110, 120 is unknown due to backlash 130. This leads inaccurate calculations, operations, and/or adjustments in gear systems.

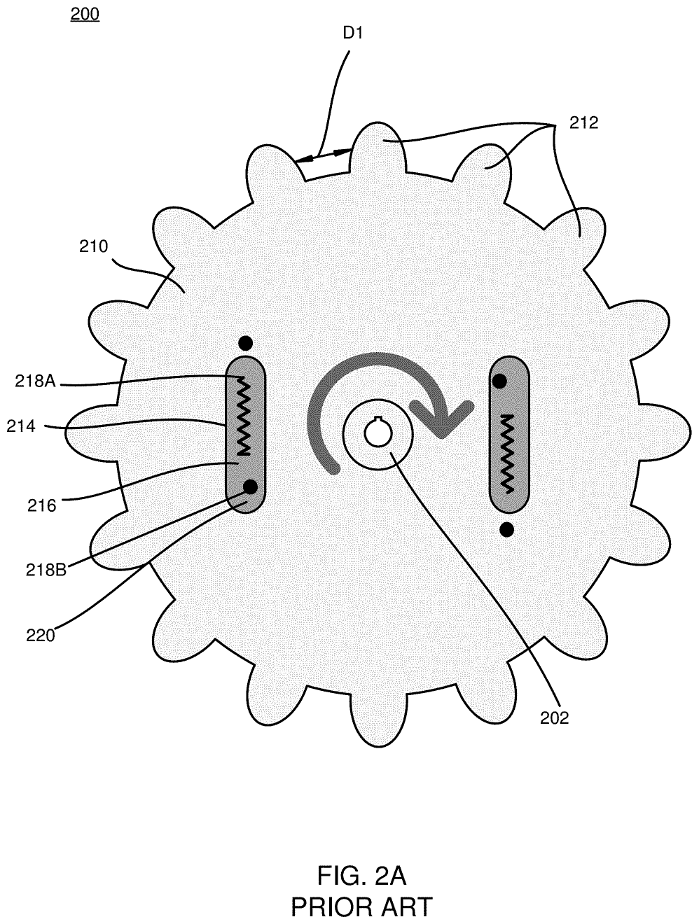

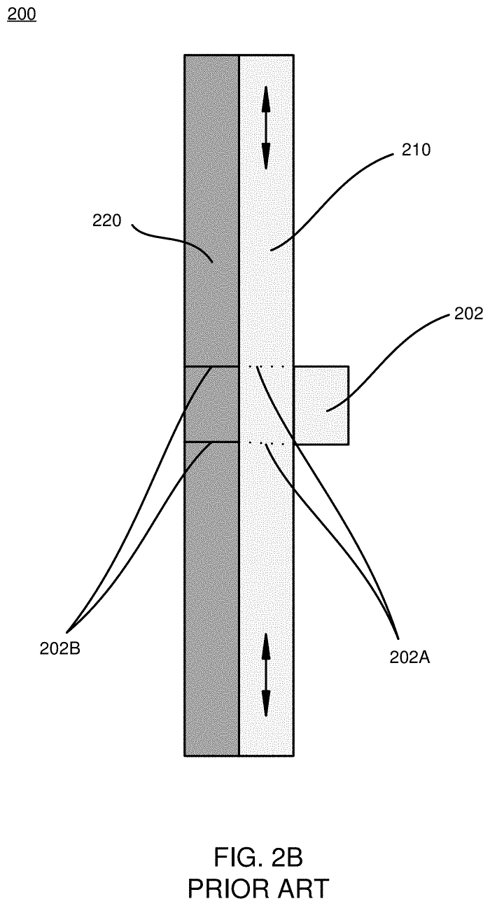

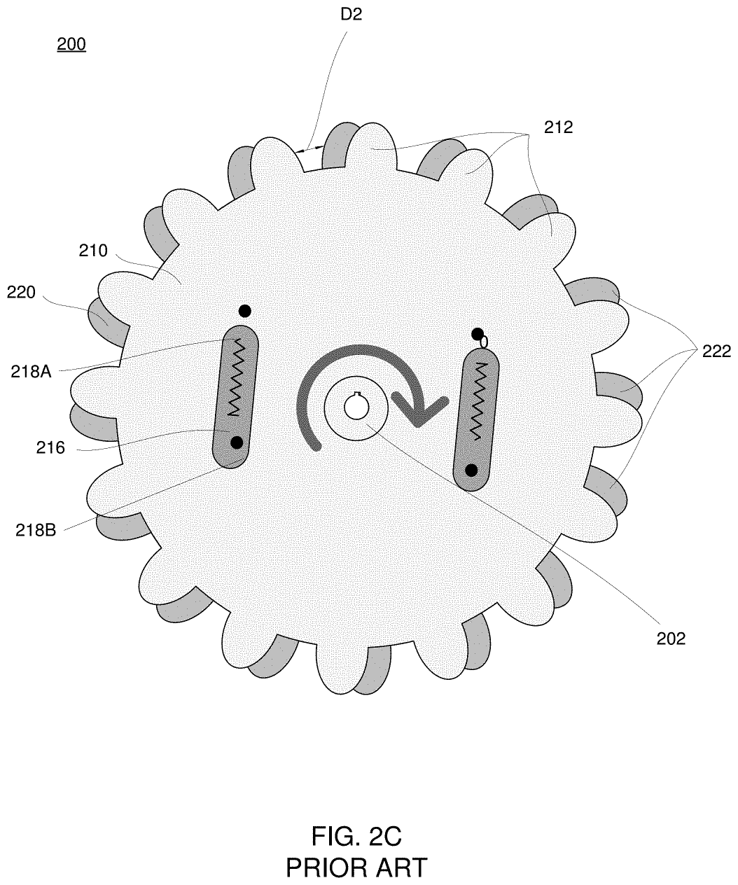

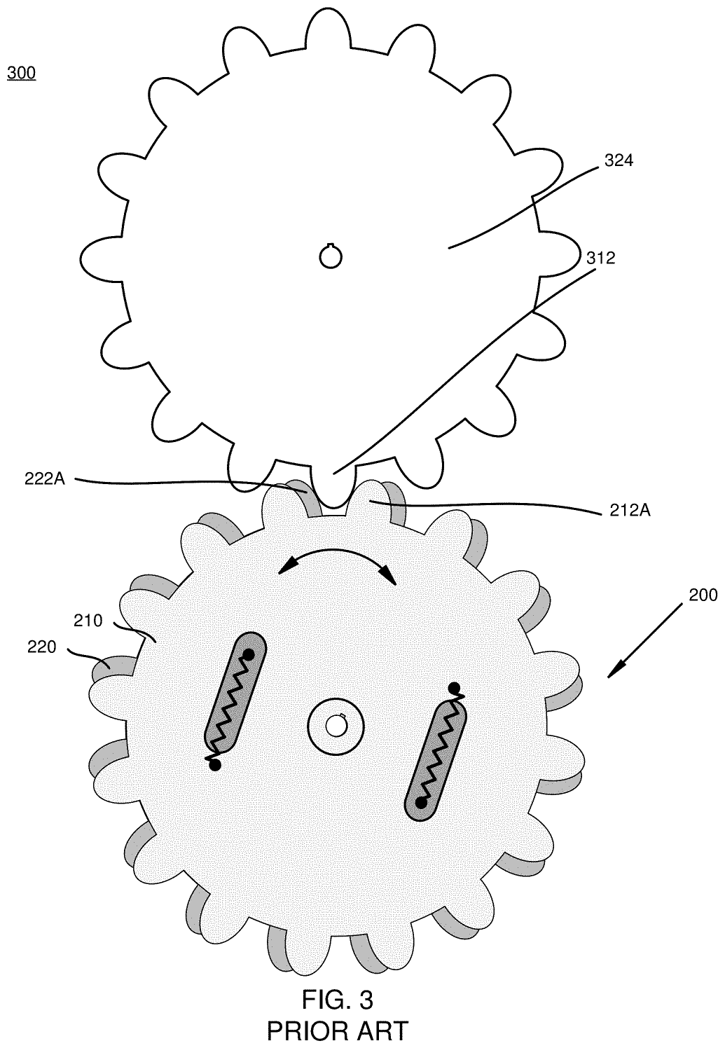

FIGS. 2A-2C and FIG. 3 illustrate traditional embodiments of anti-backlash gears. FIG. 2A illustrates a front view of a traditional anti-backlash gear 200 where two gears of the anti-backlash gear 200 are viewed as being directly superimposed on each other. FIG. 2B illustrates a straight-on side view of the traditional anti-backlash gear 200. FIG. 2C illustrates a front view of the traditional anti-backlash gear 200 wherein the two gears are in motion and not perfectly superimposed on each other.

The traditional anti-backlash gear 200 includes a floating gear 210 and a fixed gear 220 that both interface with a central hub 202. The floating gear 210 includes a plurality of rigid teeth 212. As mentioned above, the view illustrated in FIG. 2A shows the floating gear 210 directly superimposed over the fixed gear 220. The similar outlines of the floating gear 210 and the fixed gear 220 cause the floating gear 210 to mostly obscure the fixed gear 220 in FIG. 2A. Therefore, most of the fixed gear 220 is not visible in FIG. 2A, except through an aperture 214 formed through the floating gear 210.

The floating gear 210 is connected to the fixed gear 220 through the aperture 214. The floating gear 210 and the fixed gear 220 are connected to one another with a spring 216, wherein the spring is attached to the floating gear 210 at a connection point 218A on one end and is attached to the fixed gear 220 at a similar connection point 218B on the opposite end. As shown in FIG. 2A, multiple apertures may be formed in the floating gear 210 and multiple springs may be used to connect the floating gear 210 and the fixed gear 220. In the position shown in FIG. 2A, the spring 216 is not exerting a force on the gears 210, 220 such that the floating gear 210 and the fixed gear 220 remain stationary in the absence of external forces. Such a position may be referred to as an “equilibrium position.”

Although not shown in FIG. 2A, the fixed gear 220 further includes a plurality of teeth 222 (See FIG. 2C). When the floating gear 210 is superimposed directly over the fixed gear 220, a distance between the teeth 212 of the floating gear 210 and the teeth 222 of the fixed gear 222 is indicated as D1.

The floating gear 210 and the fixed gear 220 each interface with a central hub 202. As is indicated by their respective names, the fixed gear may be fixed to the central hub 202 such that the fixed gear 220 and the central hub 202 rotate at a same rate with respect to one another. In other words, as one of the central hub 202 and the fixed gear 220 rotate, the other rotates as well at the same rate. the floating gear 210 is not fixed to the central hub 202. Instead, the central hub 202 may be inserted through a hole in the floating gear 210. Because the floating gear 210 is not fixed to the central hub 202, the floating gear 210 is free to rotate independently relative to the central hub 202 and the fixed gear 220. FIGS. 2B and 2C further illustrate this feature of the floating gear 210.

FIG. 2B illustrates a side view of the traditional anti-backlash gear illustrated in FIG. 2A. As illustrated in FIG. 2B, both the fixed gear 220 and the floating gear 210 interface with the central hub 202. The central hub 202 begins outside of the floating gear 210 and the fixed gear 220 and continues through both gears. However, the fixed gear 220 is rigidly fixed to the central hub 202 (indicated by solid lines 202B representing the central hub 202) and the floating gear 210 is free to rotate about the central hub 202 (indicated by dotted lines 202A representing the central hub 202). Accordingly, the floating gear 210 may be freely rotated to any position relative to the fixed gear 220. As shown, the floating gear 210 is positioned directly adjacent to and in contact with the fixed gear 220.

FIG. 2C illustrates a front view of the traditional anti-backlash gear 200 illustrated in FIG. 2A, wherein the two gears of the anti-backlash gear 200 are turned with respect to each other such that the teeth 222 of the fixed gear 220 (disposed behind the floating gear 210) are visible through gaps in between the teeth 212 of the floating gear 210. In FIG. 2C, the floating gear 210 has been rotated in a clockwise direction relative to the fixed gear 220. With the floating gear 210 rotated relative to the fixed gear 220, the spring 216 stretches and exerts a force on the floating gear 210 and the fixed gear 220. This may be referred to as a “loaded position” of the gear 200. The force exerted on the floating gear 210 and the fixed gear 220 acts to pull or rotate the floating gear 210 back to be directly superimposed over the fixed gear 220 (See the view illustrated in FIG. 2A) when the floating gear 210 is released. Additionally, as the floating gear 210 is rotated relative to the fixed gear 220 the positions of the teeth 212 and the teeth 222 are moved closer together. For example, as shown in FIG. 2C, the distance D2 between the teeth 212 and the teeth 222 is smaller than distance D1 shown in FIG. 2A. The closing of the distance between the teeth 212 and the teeth 222 allows for a tooth of another gear engaged with the anti-backlash gear 200 to be squeezed between a tooth 212 of the floating gear 210 and a tooth 222 of the fixed gear 220. This is further explained with reference to FIG. 3.

FIG. 3 illustrates a front view of an exemplary gear system 300 including a mating gear 324 and the traditional anti-backlash gear 200 of FIGS. 2A-2C. The traditional anti-backlash gear 200 is interfacing with the mating gear 324. As shown in FIG. 3, a tooth 312 of the mating gear 324 is disposed between a tooth 212A of the floating gear 210 and a tooth 222A of the fixed gear 220. When the tooth 312 of the mating gear 324 is pinched between the teeth 212A and 222A, backlash between the teeth of gear 200 and the teeth of mating gear 324 is reduced.

The traditional anti-backlash gear 200 is configured to reduce backlash between the tooth 312 of the mating gear 324 and the teeth 212A, 222A of the traditional anti-backlash gear 200. The traditional anti-backlash gear 200 is installed by rotating the floating gear 210 to create a space between the teeth 212A, 222A which were previously overlapped in the equilibrium position of the gear 200 (See FIG. 2A). Once the floating gear 210 is rotated to a loaded position and enough space is between tooth 212A and tooth 222A to accommodate the tooth 312 of the mating gear 324 therebetween, the floating gear 210 is released to return toward equilibrium. In the process of returning toward equilibrium, the teeth 222A, 212A contact opposite sides of the tooth 312 of the mating gear 324. The force exerted by the springs 216 continuously tries to get the gears of gear 200 to return to the equilibrium position. Thus, the force of the spring 216 causes the tooth 312 of the mating gear 324 to be pinched between the teeth 212A, 222A of the traditional anti-backlash gear 200. Due to the pinching action and force of the teeth 212A, 222A on the tooth 312 caused by the spring 216, backlash between gears is reduced as shown in FIG. 3.

Traditional anti-backlash gears, such as the gear 200 described and illustrated herein, have several drawbacks and disadvantages. For example, the traditional anti-backlash gear 200 includes a plurality of separate parts that are assembled into a single gear. The traditional anti-backlash gear 200 includes at least the floating gear 210, the fixed gear 220, the central hub 202, and the springs 216. The parts shown and described in FIGS. 2A-3 do not limit what parts are included in traditional anti-backlash gears. In fact, other gears known in the art may include several other elements not listed here. For example, some traditional anti-backlash gears may include a pin that may be inserted through holes in the floating gear 210 and the fixed gear 220 to hold the gear in the loaded position while the gear is installed in place; once in place, the pin may be removed to move the gear back toward equilibrium.

Accordingly, traditional anti-backlash gears are made in several pieces that must be assembled. This increases the number of manufacturing processes and time it may take to make traditional anti-backlash gears. After all pieces are manufactured, assembly time also needs to be considered. The multiple parts, processes, and time needed to manufacture a single traditional anti-backlash gear 200 are complex, require additional time and energy to complete, and add possibilities for error in the manufacturing and assembly of the anti-backlash gears.

Furthermore, additional installation steps are needed to implement traditional anti-backlash gears. For example, a user installing the gear needs to take time and effort to properly move the floating gear 210 to the loaded position, hold the gear in the loaded position while installing the gear, and release the gear at the right time and in the right place to properly install the traditional anti-backlash gear 200. Accordingly, additional skill and training is necessary for users using and installing the gear 200 and/or other traditional anti-backlash gears. Such additional training and skill adds to the possibility that a traditional anti-backlash gear may be used or installed incorrectly.

Due to the rigid nature of the teeth of the anti-backlash gear 200, the gear must be loaded properly before installation to ensure proper force is exerted on the tooth 312 of the mating gear 324 by the teeth 212A and 222A of the traditional anti-backlash gear 200. Without proper installation, traditional anti-backlash gears may not prevent or reduce backlash properly, or at all. A user may believe that they have installed the gear correctly but may still unknowingly experience backlash in the system and incorrect positioning of the gears, which may make systems that contain such gears inaccurate and may even cause such systems to malfunction or break. Due to the limitations and disadvantages of traditional anti-backlash gears, there exists a need for simpler, more reliable anti-backlash gears that are more energy efficient, more time efficient, and easier to manufacture, install, and implement.

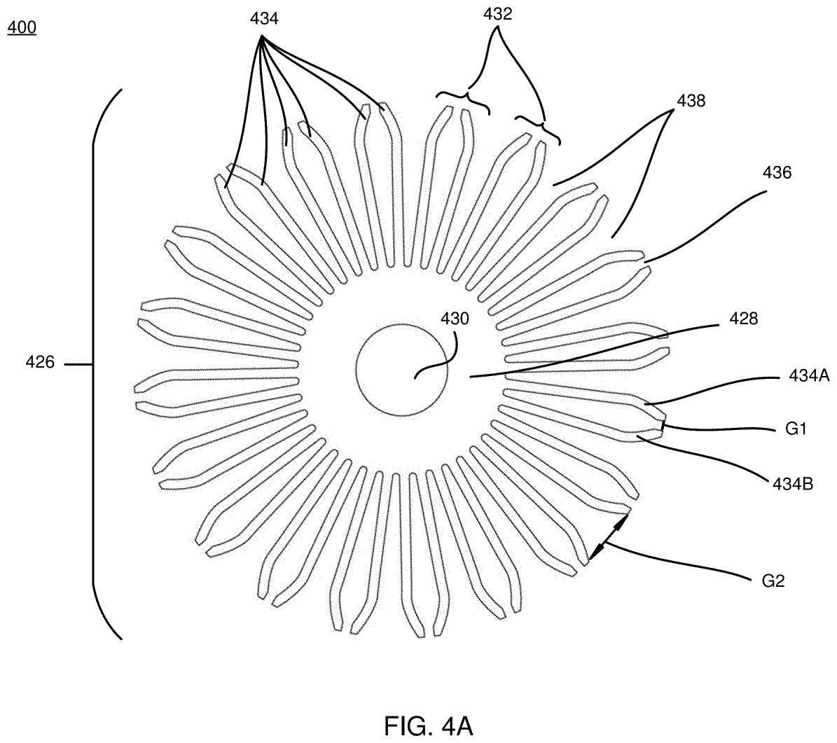

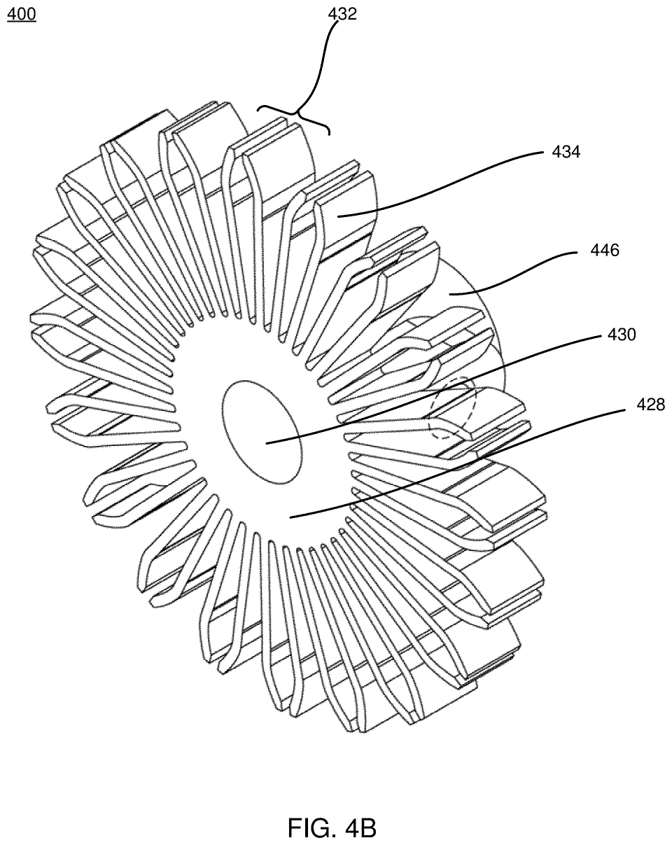

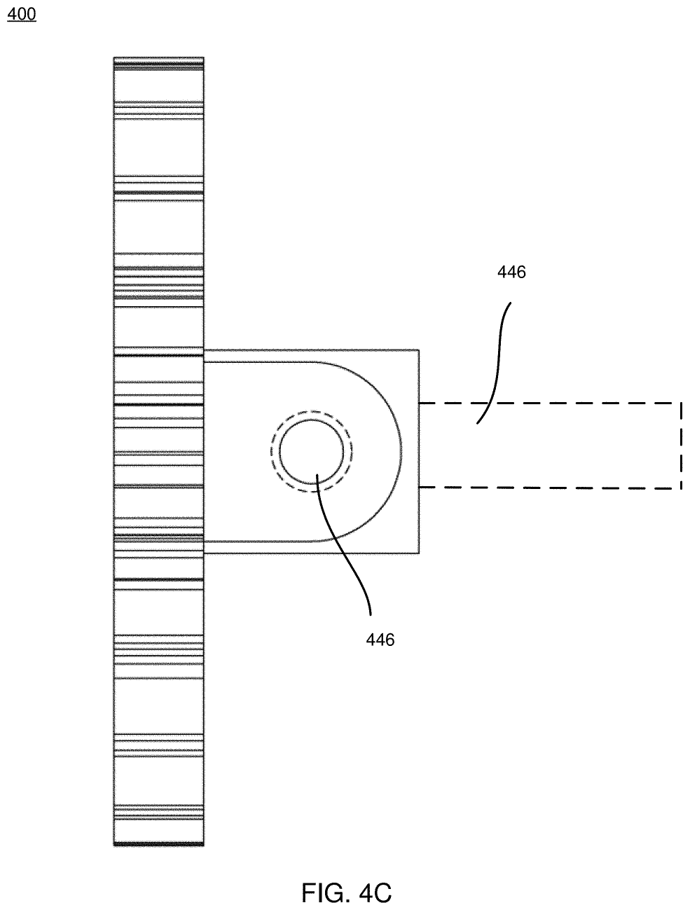

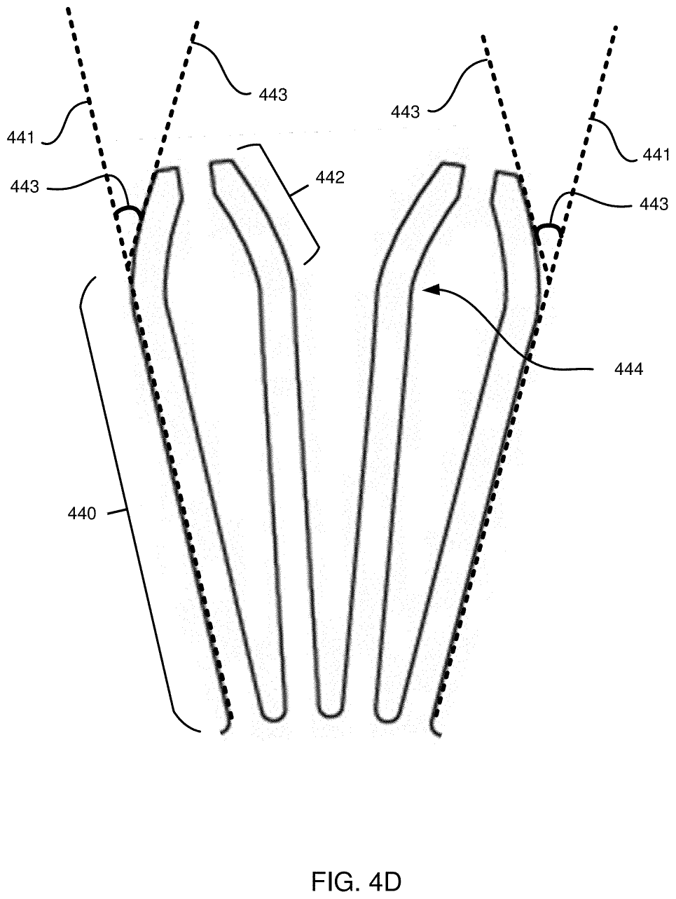

FIGS. 4A-4D illustrate various view of an anti-backlash gear 400. FIG. 4A illustrates a straight-on front view of the anti-backlash gear 400. FIG. 4B illustrates a perspective view of the anti-backlash gear. FIG. 4C illustrates a straight-on side view of the anti-backlash gear 400. FIG. 4D illustrates a zoomed-in view of a portion of the anti-backlash gear 400 to specifically illustrate the involute curve or bend at the distal ends of the compliant teeth.

The anti-backlash gear 400 illustrated in FIGS. 4A-4D is like a spur gear and comprises compliant teeth 435 that can mate with another spur gear. The anti-backlash gear 400 may alternatively mate with a linear gear (may be referred to as a rack and pinion gear). The anti-backlash gear 400 is not limited to the embodiment illustrated in FIGS. 4A-4D and may be modified to resemble a helical gear, bevel gear, miter gear, worm and worm gear, screw gear, or another gear. Additionally, the anti-backlash gear 400 may be configured to mate with any of a spur gear, helical gear, linear gear, bevel gear, miter gear, worm and worm gear, screw gear, or other gear. The functionality of the anti-backlash gear 400 is not necessarily dependent on its geometry and arises more from the compliant or spring-like nature of the compliant members 434 and compliant teeth 432. Thus, the geometry of the anti-backlash gear 400 may be altered and optimized while continuing to include compliant members as described herein.

The anti-backlash gear 400 is configured to interface with a mating gear. The combination of the anti-backlash gear 400 and the mating gear may be implemented to execute finely tuned rotations or movements of a device. In an exemplary use-case, the anti-backlash gear 400 is implemented in an antenna system to drive finely tuned operations and movement changes of an electronically scanning antenna array. The anti-backlash gear 400 is particularly suitable in implementations that do not require a high torque load. Further, the anti-backlash gear 400 is particularly beneficial when a gear changes its direction of rotation and/or when its important to ensure that a gear is rotated with a high degree of precision.

The anti-backlash gear 400 illustrated in FIGS. 4A-4D does not require the use of a fixed gear and a floating gear, like the traditional anti-backlash gear 200 illustrated in FIGS. 2A-2C and 3. The anti-backlash gear 400 represents a significant improvement over the traditional anti-backlash gear 200 because it reduces manufacturing cost, reduces the quantity of separate components that may fail during operation, and enables greater degrees of precision when rotating the anti-backlash gear 400 and a mating gear.

The anti-backlash gear 400 includes a gear body 426. The gear body 426 is composed of a central hub 428 comprising a central hole 430 disposed therethrough. The gear body 426 is further composed of a plurality of compliant teeth 432. Each of the compliant teeth 432 is composed of a pair of compliant members, including a first compliant member 434A and a second compliant member 434B (may generically be referred to as compliant members 434 as discussed herein). Each pairing of compliant members 434A, 434B comprises a member gap 436 disposed between the first compliant member 434A and the second compliant member 434B. The distance of the member gap 436 varies during operation and is referred to herein as G1. Further, the anti-backlash gear 400 comprises a teeth gap 438 disposed between neighboring pairs of compliant teeth 432. The distance of the teeth gap 438 varies during operation and is referred to herein as G2.

The central hub 428 defines a central-most region of the anti-backlash gear 400. The central hub 428 comprises the central hole 430 disposed therethrough. The center point of the central hole 430 is the central-most point of the anti-backlash gear 400. The central hole 430 is configured to receive a shaft of a corresponding motor or other driver. The shaft may engage with the central hub 428 and cause the anti-backlash gear to rotate in a clockwise or counter-clockwise direction on-demand.

The anti-backlash gear 400 comprises a plurality of compliant teeth 432 that may each have the same dimensions and characteristics. In an alternative embodiment, one or more of the compliant teeth 432 may have different dimensions or characteristics relative to the other compliant teeth 432. The geometries and dimensions of the compliant teeth 432 are optimized based on the implementation and may specifically be optimized and selected based on the dimensions and structure of a mating gear configured to interface with the anti-backlash gear 400.

The compliant members 434 comprise compliant characteristics such that they can bend or deform when an external pressure is applied. The compliant members 434 further comprise elastic characteristics such that the compliant members 434 will return to their original geometry, position, and orientation when the outside force is removed. The compliant members 434 thereby exhibit spring-like attributes and exert a force when deflected or deformed.

The anti-backlash gear 400 is configured to mate with a mating gear (not shown in FIGS. 4A-4D). The mating gear comprises a plurality of mating teeth that are configured to be disposed within the teeth gap 438 defined by two compliant teeth 432. The mating teeth engage with the anti-backlash gear 400 and cause the distance G2 of the teeth gap 438 to widen by causing at least two compliant members 434 to bend away from a mating tooth. Thus, the distance G2 of the teeth gap 438 changes during operation as the anti-backlash gear 400 interfaces with a mating gear.

Further, the distance G1 of the member gap 436 changes during operation as the anti-backlash gear 400 interfaces with the mating gear. When a mating tooth engages with the anti-backlash gear 400, the mating tooth will be disposed within a tooth gap 438 and cause the neighboring compliant members 434 to bend away from the mating tooth. Thus, when the neighboring compliant members 434 bend away from the mating tooth, they will bend inward toward a center point of their respective mating teeth 432. Thus, the distance G1 of the member gap 436 will decrease and close when a mating tooth engages with the corresponding tooth gap 438. When that mating tooth no longer engages with the corresponding tooth gap 438, the compliant members 434 will bounce back to their equilibrium position and the distance G1 of the member gap 436 will return to its equilibrium position.

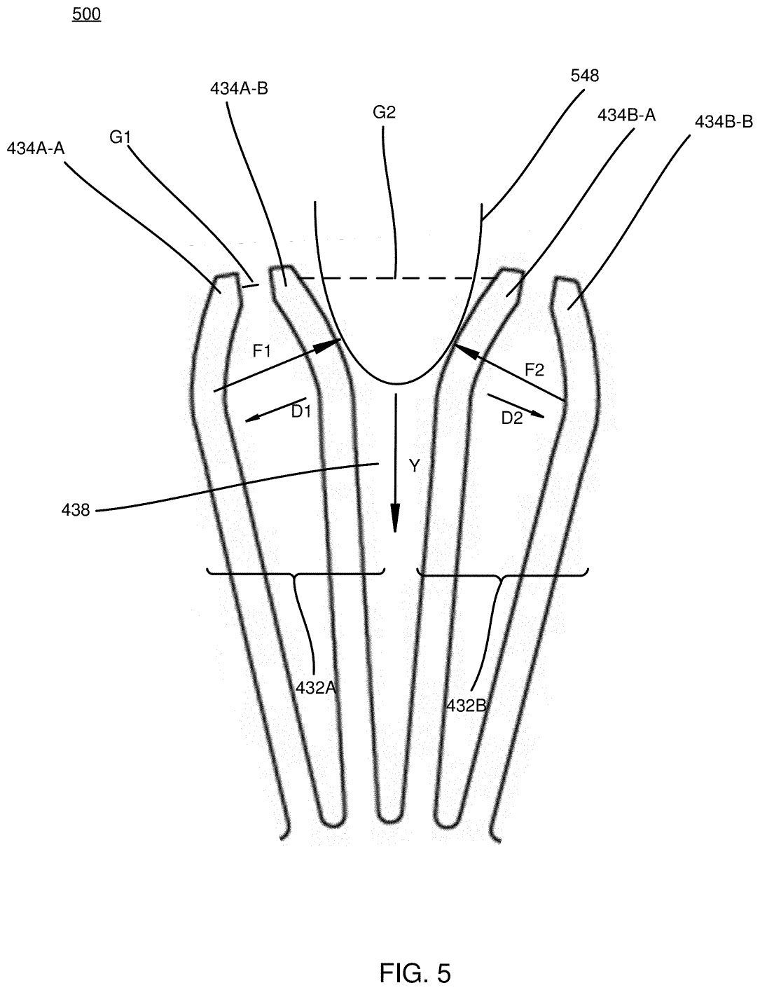

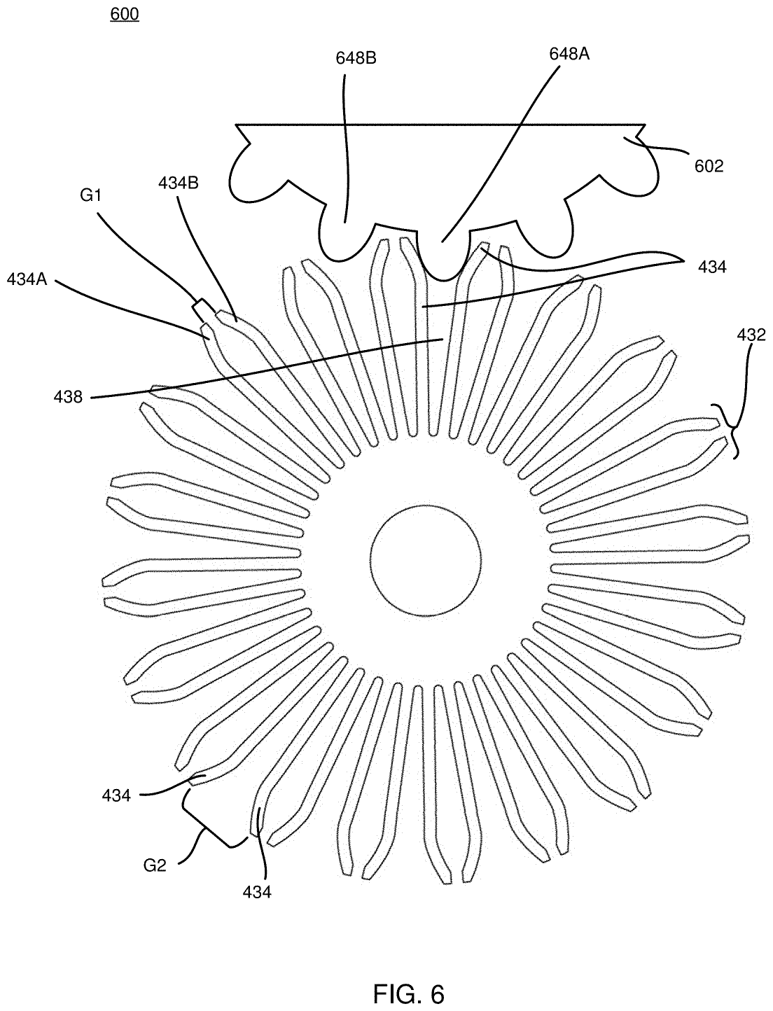

The teeth gaps 438 between the compliant teeth 432 comprise a tapered geometry such that a proximal portion of the teeth gaps 438 is narrower than a distal portion of the teeth gaps 438 (wherein the central hub 428 defines the interior/proximal region of the anti-backlash gear 400). The tapered geometry of the teeth gaps 438 enables the anti-backlash gear 400 to interface with a mating tooth of a mating gear. The mating tooth of the mating gear engages with the tooth gap 438 between compliant teeth 432. The mating tooth may thereby widen the distance G2 between the compliant teeth 432. When a compliant member 434 is deformed or deflected by an outside force, (such as a mating tooth of a mating gear) the compliant, elastic nature of each compliant member 434 acts to move the deflected compliant member 434 back to its equilibrium position (further illustrated in FIGS. 5 and 6).

The anti-backlash gear 400 may be fabricated using additive manufacturing processes, including plastic additive manufacturing and/or metal additive manufacturing. The additive manufacturing (three-dimensional printing) processes may be done in metal, alloy, plastic, or any other material comprising suitable strength, elasticity, and durability for a desired application. The anti-backlash gear 400 is thereby formed as a single unit such that the fabrication process does not include any separate joining processes for joining separate components. In this case, the central hub 428 and the compliant members 434 extending radially outward from the central hub 428 are all manufactured as a single indivisible unit using metal additive manufacturing processes.

While it may be advantageous to print the anti-backlash gear as a single indivisible element, the disclosure is not limited to such manufacturing techniques. For example, the anti-backlash gear 400 may be manufactured through molding, casting, subtractive manufacturing techniques (e.g., cutting sections out of a piece of raw material), or any other known manufacturing technique. Furthermore, the anti-backlash gear 400 may be fabricated as separate discrete pieces that are assembled and joined together after each piece is fabricated. The method of manufacture is not specifically limited for the anti-backlash gear 400.

FIG. 4B illustrates a perspective view of the anti-backlash gear 400 according to at least one embodiment of the disclosure. As shown in FIG. 4B, the anti-backlash gear 400 may include a shaft 446 protruding from a back side of the anti-backlash gear 400. The shaft 446 may be hollow with a hole formed therethrough, and may be a part of the unitary, single indivisible the anti-backlash gear 400. In other words, all the anti-backlash gear 400, including the shaft 446, may be a single indivisible element that may be printed or formed in accordance with any known manufacturing technique. The shaft 446 may also be fabricated as a piece that is separate from gear body 426 and may be joined with gear body 426 in a separate manufacturing operation.

FIG. 4C illustrates a side view of the anti-backlash gear 400. As shown in FIG. 4C, shaft 446 may include a hole to receive a set screw for attaching the anti-backlash gear 400 to a shaft. An example shaft to which the anti-backlash gear 400 may be attached is identified and outlined in FIG. 4C. Methods of attaching the anti-backlash gear 400 to a shaft are not limited to set screws. Any acceptable method of fixing the anti-backlash gear 400 to a shaft may be used.

FIG. 5 is a schematic illustration of a portion of an anti-backlash system 500. The anti-backlash system 500 includes an anti-backlash gear 400 and further includes a mating gear (only partially visible in FIG. 5). FIG. 5 illustrates wherein a mating tooth 548 of the mating gear is interfacing with two compliant teeth 432 of the anti-backlash gear 400. The mating tooth 548 enters between two neighboring compliant teeth 432, including a first compliant tooth 432A and a second compliant tooth 432B. The mating tooth 548 causes two compliant members 434A-B, 434B-A to deform and bend inward toward the center of their respective compliant teeth 432A, 432B.

The mating gear (not fully shown) and the anti-backlash gear 400 (not fully shown) rotate in opposite directions. In most implementations, a shaft disposed through the central hole 430 causes the anti-backlash gear to rotate in a first rotational direction. When the compliant teeth 432 of the anti-backlash gear 400 interface with the mating teeth of the mating gear, the anti-backlash gear 400 thereby causes the mating gear to rotate in the opposite rotational direction. Thus, the mating gear and the anti-backlash gear 400 are continuously rotating during operation, and different mating teeth are engaging with different teeth gaps 438 of the anti-backlash gear 400.

FIG. 4D illustrates the zoomed-in view of a portion of the anti-backlash gear, and specifically of two compliant teeth 432 of the anti-backlash gear. As shown in FIG. 4D, the compliant members 434 comprise a curvature or bend. This curvature marks the separation between a “proximal member portion” and a “distal member portion” as described herein.

The compliant members 434 each comprise a proximal member portion 440 and a distal member portion 442. The proximal member portion 440 is located proximal (nearest) to the central hub 428. The proximal member portion 440 extends outward relative to the central hub 428 at an angle that is perpendicular or nearly perpendicular to a circumference of the central hub 428. The distal member portion 442 is disposed distal to the central hub relative to the proximal member portion (i.e., farther from the central hub 428 and forming the exterior circumference of the anti-backlash gear 400). The distal member portion 442 is disposed at a non-perpendicular angle relative to a circumference of the central hub 428.

The proximal member portion 440 is positioned along a proximal line 441 that extends radially from the central hub 428 of the anti-backlash gear 400. It should be appreciated that the proximal line 441 need not be perfectly radial relative to the central hub 428 or perfectly straight. The distal member portion 440 is angled relative to the proximal member portion 440 such that the distal member portion 442 extends along a distal line 443. The relative angle 445 between the proximal line 441 and the distal line 443 is due to the involute curvature 444 of the compliant member 434. The relative angle 445 may comprise from about 10° to about 50° in various embodiments.

In an implementation, the compliant member 434 comprises a bend that forms the relative angle 445 between the proximal line 441 and the distal line 443. In another implementation, the compliant member 434 does not comprise a bend, and the difference in orientation of the proximal line 441 relative to the distal line 443 is formed by the involute curvature 444. In some implementations, neither of the proximal member portion 440 or the distal member portion 442 forms a straight line, and instead comprises a gradual involute curvature 444 along the length of the compliant member 434. In another implementation, portions of the proximal member portion 440 may comprise a straight line while the entirety of the distal member portion 442 comprises a gradual curve as part of the involute curvature 444 of the compliant member 434.

The pairs of compliant members 434A, 434B form a single compliant tooth 432. The pairs of compliant members 434A, 434B are configured to curve inward toward a center of the compliant tooth 432 and toward each other. Each of two compliant members 434A, 434B may comprise an involute curvature relative to a radial line extending from the central hub 428. For example, the first compliant member 434A may be bent relative to a radial line extending from the central hub 428 by an angle of 30°. The second compliant member 434B is bent in the opposite direction relative to the first compliant member 434A but may still be bent relative to a radial line extending from the central hub 428 by an angle of 30° (wherein the first compliant member 434A is measured by the bend in a clockwise direction relative to the radial line, and the second compliant member 434B is measured by the bend in a counterclockwise direction relative to the radial line).

FIG. 5 illustrates the mating tooth 548 interfacing with the tooth gap 438 defined by the first compliant tooth 432A and the second compliant tooth 432B. The mating tooth 548 enters in the Y-axis direction as shown in FIG. 5. The mating tooth 548 comprises a width that is greater than the distance G2 of the tooth gap 438. Thus, the mating tooth 548 causes neighboring compliant members 434 to bend away from the mating tooth and toward a center of their respective mating teeth 432A, 432B. As shown in FIG. 5, the compliant member 434A-B is deflected in a direction D1, and the compliant member 434B-A is deflected in direction D2. The deflection of compliant members 434A-B and 434B-A cause the distance G2 to expand as the mating tooth 548 enters the tooth gap 438 and expands the distance between compliant members 434A-B and 434B-A.

The elastic nature of the compliant members 434 enable the compliant members 434 to return to their original geometry and orientation when the force of the mating tooth is removed (this occurs when the anti-backlash gear 400 and the mating gear rotate). The compliant members 434 thus return to their respective equilibrium positions when an external force is no longer applied. The compliant members 434 further exert forces Fl and F2 against the mating tooth 548 due to their compliant and elastic characteristics. The forces Fl and F2 exerted against the mating tooth 548 reduce or eliminate the backlash between the anti-backlash gear 400 and the mating gear. The anti-backlash gear 400 reduces and/or closes gaps between compliant members 434 and the mating tooth 548.

FIG. 6 is a schematic illustration of an anti-backlash system 600 comprising an anti-backlash gear 400 and a mating gear 602 (only a portion of the mating gear 602 is shown in FIG. 6). The mating gear 602 is configured to interface with the anti-backlash gear 400.

The mating gear 602 includes a first mating tooth 648A and a second mating tooth 648B. The first mating tooth 648A is disposed between two compliant teeth 432 of the anti-backlash gear 400. The first mating tooth 648A causes two compliant members 434 to displace and bend toward a center of their respective compliant teeth 432. The first mating tooth 648A is wider than certain parts of the tooth gap 438 and therefore spreads the compliant members 434 apart from each other. The elastic nature of the compliant members 434 causes them to the spring back and press against the first mating tooth 648A. This reduces or eliminates backlash within the anti-backlash system 600.

The anti-backlash gear 400 and/or the mating gear 602 may be driven by a motor or other driver. When one of the gears 400, 602 rotates, the rotating gear imparts motion to the other gear. The mating teeth 648 continually enter and exit teeth grooves 438 as the gears 400, 602 rotate. Similarly, the compliant teeth 432 continually enter and exit grooves of the mating gear 602 as the gears 400, 602 rotate.

The anti-backlash gear 400 presents numerous benefits over traditional anti-backlash gears. Firstly, while traditional anti-backlash gears are made of multiple different parts, the anti-backlash gear 400 may be manufactured as a single indivisible element. For this reason, the anti-backlash gear 400 may be manufactured in one process instead of multiple processes, which are needed for fabricating and assembling traditional anti-backlash gears.

Additionally, when traditional anti-backlash gears are installed, they must be pre-loaded by twisting the floating gear or the fixed gear to add tension to the springs. Then traditional anti-backlash gear must be installed and the tension in the springs released at the right time in the right place to properly install the traditional anti-backlash gear. In contrast, the solid nature of the anti-backlash gear 400 allows the gear to engage with other gears in a manner like that of any gear. Accordingly, the anti-backlash gear 400 of the present disclosure is easier to manufacture, install, and use than traditional anti-backlash gears. This reduction in parts, manufacturing processes, and steps to install the anti-backlash gears 400 described herein money, time, energy, study, and skill that are required in the fabrication and use of traditional anti-backlash gears.

Furthermore, the flexibility, elasticity, and compliance of compliant members of the anti-backlash gears according to the present disclosure allows the anti-backlash gears to accommodate and fit multiple sizes of gears in a gear system. The flex in compliant members allows said members to flex to accommodate different sized teeth of gears. Accordingly, the anti-backlash gears disclosed herein allow for simpler and more efficient manufacturing, implementation, and use over traditional anti-backlash gears.

The anti-backlash gear 400 of the present disclosure is not limiting and other similar embodiments of the anti-backlash gears are considered within the scope of this disclosure. For example, the shape of compliant members may be different than that shown in the figures and still be within the scope of the disclosure. For example, compliant members may have a different shape and profile than that shown in the figures and still perform the same or similar functions of preventing backlash in gear systems. Compliant members may have cross-sections that are circular, elliptical, rectangular, or other geometric shapes without departing from the scope of this disclosure. While compliant members are shown as members that are slightly bent at the ends, the compliant members may have a different shape or profile without departing from the disclosure (e.g., straight, curved more, curved less, curved outward, curved inward). Furthermore, any number of compliant members may be used to form a single compliant tooth and any number of compliant members or compliant teeth may be disposed around the anti-backlash gear, depending on the needs of a current situation.

While the anti-backlash gear 400 is shown as being a substantially circular in shape, the gear may have any acceptable shape known for gears without departing from the scope of the disclosure. For example, these compliant members may be utilized with spur gear involute profiles, as shown, or with any other gear types (e.g.., miter gears or worm wheels) without departing from the disclosure. Similarly, the anti-backlash gear 400 may accommodate shafts of any shape, not just circular/cylindrical.

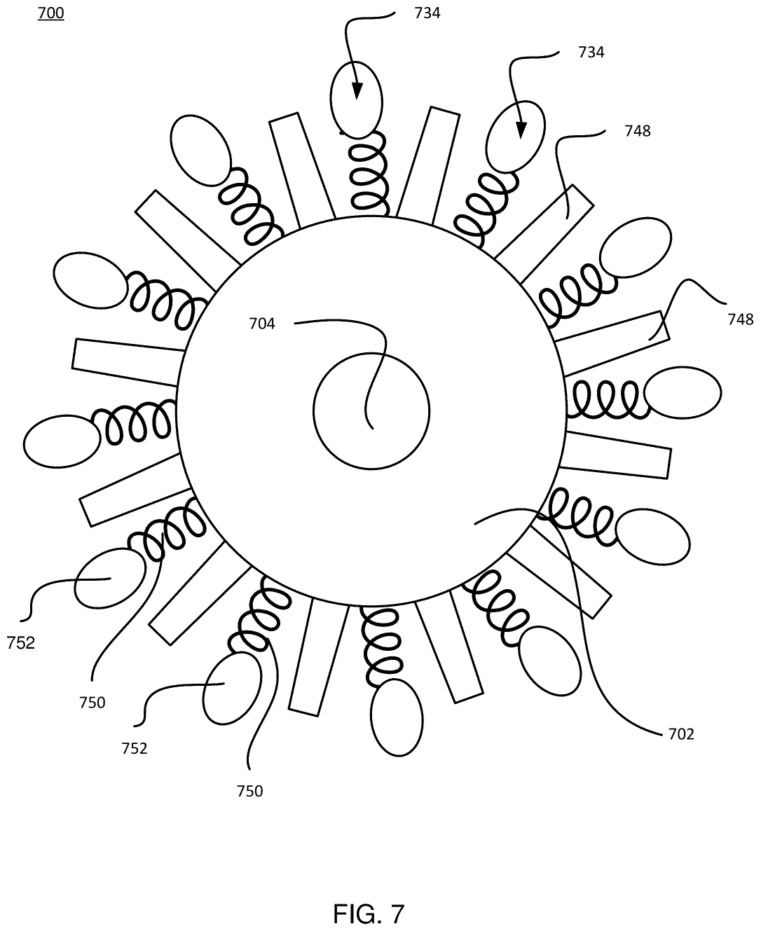

FIG. 7 is a schematic illustration of an anti-backlash gear 700 as seen from a straight-on front view. The anti-backlash gear 700 includes a central hub 702 with a central hole 704 disposed therethrough. The anti-backlash gear 700 includes a plurality of compliant members 734 attached to the central hub 702 and extending radially outward from the central hub 702. The anti-backlash gear 700 further may include a plurality of support members 748 disposed between the compliant members 734.

The compliant members 734 each comprise a compliant coupler 750 and a head 752. The compliant coupler 750 secures the head 752 to the central hub 702. The compliant coupler 750 comprises compliant or spring-like characteristics. In some implementations, the compliant coupler 750 includes a spring, such as a coil spring as shown in FIG. 7, a flat spring, a machined spring, a molded spring, or another configuration comprising springlike characteristics. The compliant coupler 750 deforms when the head 752 encounters a mating gear, and then the compliant coupler 750 rebounds to its equilibrium position when a force from the mating gear is removed. The compliant coupler 750 may further bend and depress to either side. The support members 748 may be included to prevent the compliant couplers 750 from bending too far in either direction. The heads 752 of the compliant members 734 are configured to interface with a groove between two teeth of a mating gear.

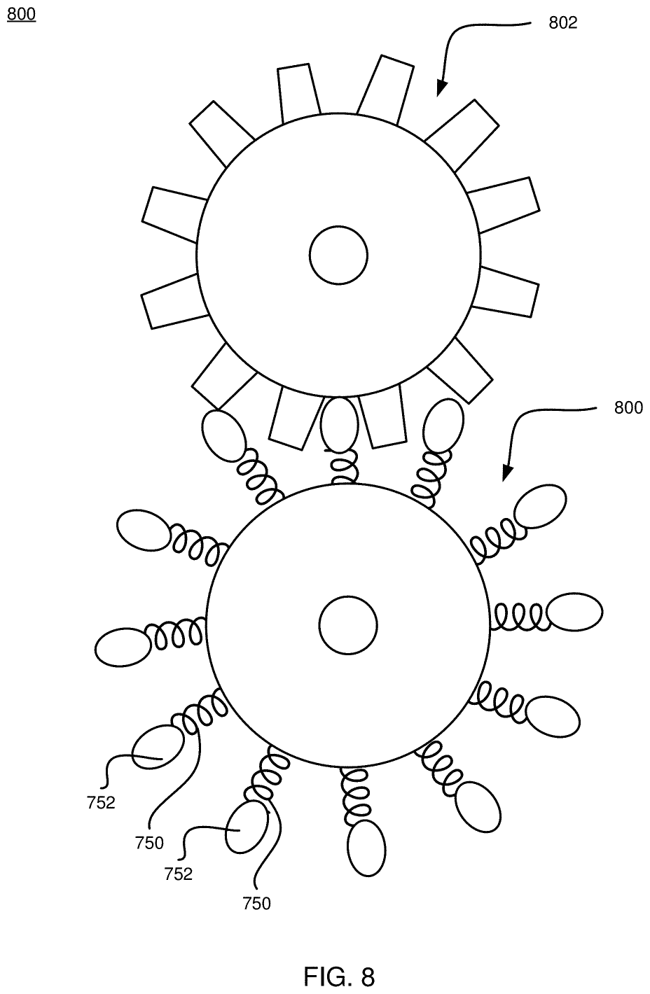

FIG. 8 is a schematic illustration of an anti-backlash system 800 comprising an anti-backlash gear 700 and a mating gear 802. As shown in FIG. 8, the head 752 of the compliant member 734 is configured to interface with a gap disposed between two teeth of the mating gear 802. The compliant coupler 750 depresses and enables the mating gear 802 to be disposed nearer to the anti-backlash gear 700.

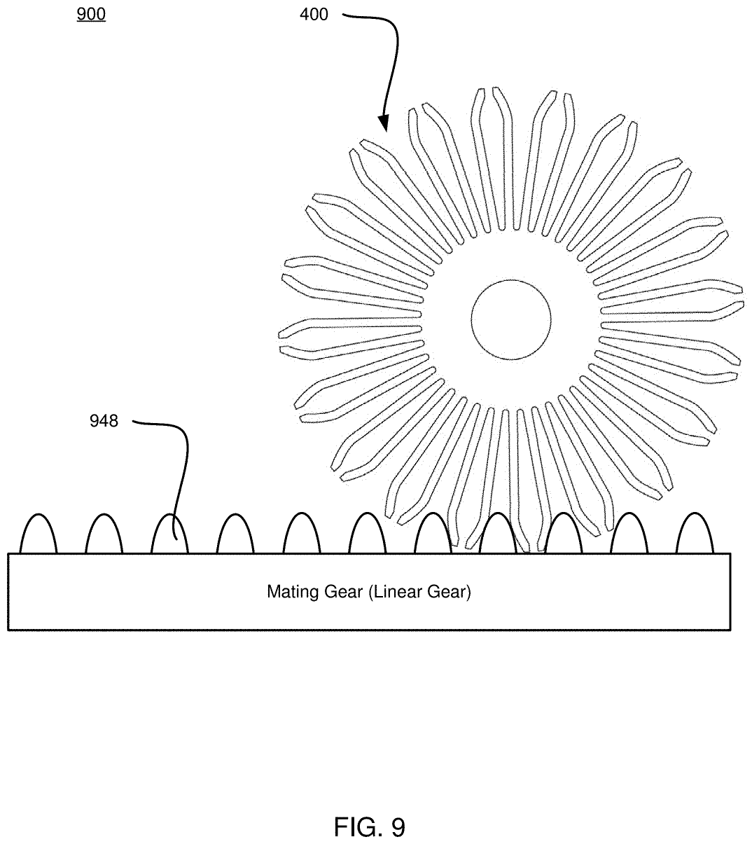

FIG. 9 is a schematic illustration of an anti-backlash system 900 comprising an anti-backlash gear 400 and a mating gear. The mating gear depicted in the system 900 is a linear gear comprising a plurality of mating teeth 948. As shown in FIG. 9, the system 900 reduces or eliminates backlash between the anti-backlash gear 400 and the mating gear because the compliant members of the anti-backlash gear 400 are capable of depressing when exposed to an outside force (i.e., the force of the mating gear pressing against the compliant members) and can then return to their equilibrium positions when the outside force is removed.

It should be appreciated that the systems depicted in the figures are illustrative only, and the disclosure is not limited to the spur gears or linear gears explicitly illustrated herein. The anti-backlash gears described herein may be implemented in various gear systems, including, for example, spur gears, linear gears, helical gears, double helical gears, herringbone gears, bevel gears, worm gears, hypoid gears, and so forth. Additionally, the anti-backlash gear itself may be implemented with various configurations and geometries while maintaining the “compliant” or springlike characteristics of the compliant members.

### EXAMPLES

The following examples include exemplary embodiments of the disclosure.

Example 1 is a gear. The gear includes a plurality of compliant members attached to the central hub and extending outward to form at least a portion of the gear. The gear is such that each of the plurality of compliant members is configured to elastically deform when exposed to an applied force.

Example 2 is a gear as in Example 1, wherein the gear is an anti-backlash gear configured to reduce or eliminate backlash between the gear and a mating gear during operation.

Example 3 is a gear as in any of Examples 1-2, further comprising a plurality of compliant teeth, wherein each of the plurality of compliant teeth comprises two or more of the plurality of compliant members.

Example 4 is a gear as in any of Examples 1-3, further comprising a tooth gap disposed between two neighboring compliant teeth of the plurality of compliant teeth, and wherein the tooth gap is configured to receive a mating tooth of a mating gear.

Example 5 is a gear as in any of Examples 1-4, wherein the tooth gap comprises a variable distance such that the tooth gap comprises: an equilibrium distance when the two neighboring compliant teeth are in a resting position; and an engaged distance when the mating tooth of the mating gear is disposed between the two neighboring compliant teeth; wherein the equilibrium distance is shorter than the engaged distance; and wherein the tooth gap returns to the equilibrium distance when the mating tooth of the mating gear is no longer disposed between the two neighboring compliant teeth.

Example 6 is a gear as in any of Examples 1-5, wherein each of the plurality of compliant teeth comprises a member gap disposed between the two or more of the plurality of compliant members, and wherein the member gap comprises a variable distance such that the member gap comprises: an equilibrium distance when none of the two or more of the plurality of compliant members is deformed or displaced; and an engaged distance when at least one of the two or more of the plurality of compliant members is deformed or displaced.

Example 7 is a gear as in any of Examples 1-6, wherein the member gap comprises the equilibrium distance when none of the two or more of the plurality of compliant members is deformed or displaced by a presence of a mating tooth of a mating gear; wherein the member gap comprises the engaged distance when at least one of the two or more of the plurality of compliant members is deformed or displaced by the mating tooth of the mating gear; and wherein the equilibrium distance is longer than the engaged distance.

Example 8 is a gear as in any of Examples 1-7, wherein each of the plurality of compliant members comprises a compliant coupler and a head, and wherein the compliant coupler attaches the head to the central hub.

Example 9 is a gear as in any of Examples 1-8, wherein the compliant coupler is a spring configured to depress in a radial direction relative to a circumference of the central hub.

Example 10 is a gear as in any of Examples 1-9, wherein each of the plurality of compliant members comprises a proximal compliant portion located nearer to the central hole and a distal compliant portion located farther from the central hole, and wherein: the proximal compliant portion is disposed at an angle parallel to a radial line extending from a center point of the central hole; and the distal compliant portion is disposed at an angle non-parallel to the radial line extending from the center point of the central hole.

Example 11 is a gear as in any of Examples 1-10, wherein the angle non-parallel to the radial line extending from the center point of the central hole comprises an angle from about 20° to about 50° bent relative to the radial line extending from the center point of the central hole.

Example 12 is a gear as in any of Examples 1-11, further comprising a compliant tooth comprising two compliant members of the plurality of compliant members, and wherein: the compliant tooth comprises a first compliant member comprising a first distal compliant portion bending inward toward a center of the compliant tooth; the compliant tooth comprises a second compliant member comprising a second distal compliant portion bending inward toward the center of the compliant tooth; an angle of the first compliant member is equal to an angle of the second compliant member relative to a radial line extending from a center of the central hole.

Example 13 is a gear as in any of Examples 1-12, wherein the gear is fabricated as a single element using additive manufacturing techniques.

Example 14 is a gear as in any of Examples 1-13, wherein the gear is fabricated using the additive manufacturing techniques such that fabrication does not comprise any joining process for joining separate components.

Example 15 is a gear as in any of Examples 1-14, wherein the gear is fabricating using metal additive manufacturing techniques or plastic additive manufacturing techniques.

Example 16 is a gear as in any of Examples 1-15, wherein a length and elasticity of the plurality of compliant members is optimized to reduce or eliminate backlash between the gear and a mating gear.

Example 17 is a gear as in any of Examples 1-16, wherein the gear is implemented in an electronically scanning antenna array to precisely alter a directional orientation of the electronically scanning antenna array.

Example 18 is a gear as in any of Examples 1-17, wherein the central hole is configured to receive a shaft that drives rotation of the gear, and wherein the gear and the shaft are components of an antenna assembly.

Example 19 is a gear as in any of Examples 1-18, wherein two or more of the plurality of compliant members interface with a mating tooth of a mating gear during operation, and wherein the two or more of the plurality of compliant members form an interference fit with the mating tooth of the mating gear.

Example 20 is a gear as in any of Examples 1-19, wherein each of the plurality of compliant members comprises an involute curve.

Example 21 is a gear as in any of Examples 1-20, wherein each of the plurality of compliant members is fabricated of a material capable of deforming when exposed to the applied force and then returning to an equilibrium state when the applied force is removed.

Example 22 is a gear as in any of Examples 1-21, wherein the gear is configured to drive rotation of a mating gear with a high degree of precision.

Example 23 is a gear as in any of Examples 1-22, wherein the gear is configured to drive rotation of a mating gear in a clockwise direction and a counterclockwise direction with reduced or eliminated backlash.

Example 24 is a gear as in any of Examples 1-23, wherein the plurality of compliant members are evenly spaced apart from one another around a circumference of the central hub.

Example 25 is a gear as in any of Examples 1-24, further comprising a plurality of compliant teeth, and wherein each of the plurality of compliant teeth comprises one or more of the plurality of compliant members.

Example 26 is a gear as in any of Examples 1-25, wherein a member gap is formed between each of the compliant members.

Example 27 is a gear as in any of Examples 1-26, wherein a tooth gap is formed between each of the plurality of compliant teeth.

Example 28 is a gear as in any of Examples 1-27, wherein each of the compliant teeth include two compliant members with a gap disposed therebetween.

Example 29 is a gear as in any of Examples 1-28, wherein the compliant members of a compliant tooth are tapered such that they taper away from each other as they extend away from the central hub.

Example 30 is a gear as in any of Examples 1-29, wherein the compliant members of a compliant tooth are tapered such that they taper toward each other at distal ends of the compliant members.

Example 31 is a gear as in any of Examples 1-30, further comprising a set screw for fixing the anti-backlash gear to the shaft.

Example 32 is a gear as in any of Examples 1-31, wherein the plurality of compliant members are flexible and/or elastic such that the plurality of compliant members comprises spring-like qualities.

Example 33 is a gear as in any of Examples 1-32, wherein the gear is fabricated using subtractive manufacturing techniques.

Example 34 is a gear as in any of Examples 1-33, wherein the gear is fabricated using injection molding manufacturing techniques.

Example 35 is a gear as in any of Examples 1-34, wherein the gear is fabricated from one or more of a metal, alloy, or polymer material.

Example 36 is a gear as in any of Examples 1-35, wherein the gear interfaces with a mating gear such that one or more mating teeth of the mating gear spreads apart two or more compliant members of the plurality of compliant members to reduce backlash within a gear system.

Example 37 is a gear as in any of Examples 1-36, wherein at least one of the one or more mating teeth of the mating gear comprises a width that is larger than a tooth gap disposed between two teeth of the gear.

Example 38 is a gear as in any of Examples 1-37, wherein the gear is configured to precisely control positioning of gears or shafts in a system.

Example 39 is a gear as in any of Examples 1-38, wherein the gear system drives and positions an antenna.

Example 40 is a gear as in any of Examples 1-39, wherein the gear is an anti-backlash gear of an antenna system configured to reduce or eliminate backlash when rotating or positioning an antenna array.

Example 41 is a gear as in any of Examples 1-40, wherein the gear is a miter gear or worm gear.

Example 42 is a gear as in any of Examples 1-41, wherein the compliant coupler is configured to depress in a radial direction relative to a circumference of the central hub.

Example 43 is a gear as in any of Examples 1-42, wherein each of the plurality of compliant teeth comprises a member gap disposed between the wo or more of the plurality of compliant members, and wherein the member gap comprises a variable distance such that the member gap comprises: an equilibrium distance when none of the two or more of the plurality of compliant members is deformed or displaced; and an engaged distance when at least one of the two or more of the plurality of compliant members is deformed or displaced.

Example 44 is a gear as in any of Examples 1-43, wherein the gear is a spur gear.

Example 45 is a gear as in any of Examples 1-44, wherein the gear is a radial or circular gear.

Example 46 is a gear as in any of Examples 1-45, wherein the gear is a linear gear.

Example 47 is a gear as in any of Examples 1-46, wherein the gear is a helical gear.

Example 48 is a gear as in any of Examples 1-47, wherein the gear is a bevel gear.

Example 49 is a gear as in any of Examples 1-48, wherein the gear is a miter gear.

Example 50 is a gear as in any of Examples 1-49, wherein the gear is a worm and worm gear.

Example 51 is a gear as in any of Examples 1-50, wherein the gear is a screw gear.

Example 52 is a gear as in any of Examples 1-51, wherein the gear is configured to mate with one or more of a spur gear, circular gear, linear gear, helical gear, bevel gear, miter gear, worm gear, screw gear, or internal gear.

Example 53 is a gear as in any of Examples 1-52, further comprising a compliant tooth comprising two compliant members of the plurality of compliant members, and wherein: the compliant tooth comprises a first compliant member comprising a first distal compliant portion bending inward toward a center of the compliant tooth; and the compliant tooth comprises a second compliant member comprising a second distal compliant portion bending inward toward the center of the compliant tooth.

Example 54 is a gear as in any of Examples 1-53, wherein: the first compliant member comprises an involute curvature forming the bend inward toward the center of the compliant tooth; and the second compliant member comprises an involute curvature forming the bend inward toward the center of the compliant tooth.

Example 55 is a gear as in any of Examples 1-54, wherein the gear is fabricated using wire Electric Discharge Machining (EDM) techniques.

Example 56 is a gear as in any of Examples 1-55, wherein the gear is configured to mate with a linear gear.

Example 57 is a system. The system includes the gear of any of Examples 1-56. The system further includes a mating gear comprising a plurality of mating teeth.

Example 58 is a method of fabricating the gear of any of Example 1-56.

The foregoing description has been presented for purposes of illustration. It is not exhaustive and does not limit the invention to the precise forms or embodiments disclosed. Modifications and adaptations will be apparent to those skilled in the art from consideration of the specification and practice of the disclosed embodiments. For example, components described herein may be removed and other components added without departing from the scope or spirit of the embodiments disclosed herein or the appended claims, if any.

Other embodiments will be apparent to those skilled in the art from consideration of the specification and practice of the disclosure disclosed herein. It is intended that the specification and examples be considered as exemplary only, with a true scope and spirit of the invention being indicated by the following claims, if any.

What is claimed is:

1. A gear comprising:
a plurality of compliant members extending outward to form at least a portion of the gear;
wherein each of the plurality of compliant members is configured to elastically deform when exposed to an applied force.

2. The gear of claim 1, wherein the gear is an anti-backlash gear configured to reduce or eliminate backlash between the gear and a mating gear during operation.

3. The gear of claim 1, further comprising a plurality of compliant teeth, wherein each of the plurality of compliant teeth comprises two or more of the plurality of compliant members.

4. The gear of claim 3, further comprising a tooth gap disposed between two neighboring compliant teeth of the plurality of compliant teeth, and wherein the tooth gap is configured to receive a mating tooth of a mating gear.

5. The gear of claim 4, wherein the tooth gap comprises a variable distance such that the tooth gap comprises:
an equilibrium distance when the two neighboring compliant teeth are in a resting position; and
an engaged distance when the mating tooth of the mating gear is disposed between the two neighboring compliant teeth;
wherein the equilibrium distance is shorter than the engaged distance; and
wherein the tooth gap returns to the equilibrium distance when the mating tooth of the mating gear is no longer disposed between the two neighboring compliant teeth.

6. The gear of claim 3, wherein each of the plurality of compliant teeth comprises a member gap disposed between the wo or more of the plurality of compliant members, and wherein the member gap comprises a variable distance such that the member gap comprises:
an equilibrium distance when none of the two or more of the plurality of compliant members is deformed or displaced; and
an engaged distance when at least one of the two or more of the plurality of compliant members is deformed or displaced.

7. The gear of claim 6, wherein the member gap comprises the equilibrium distance when none of the two or more of the plurality of compliant members is deformed or displaced by a presence of a mating tooth of a mating gear;
wherein the member gap comprises the engaged distance when at least one of the two or more of the plurality of compliant members is deformed or displaced by the mating tooth of the mating gear; and
wherein the equilibrium distance is longer than the engaged distance.

8. The gear of claim 1, wherein each of the plurality of compliant members comprises a compliant coupler and a head, and wherein the compliant coupler attaches the head to a central hub of the gear.

9. The gear of claim 8, wherein the compliant coupler is configured to depress in a radial direction relative to a circumference of the central hub.

10. The gear of claim 1, wherein the gear is one of a spur gear, a linear gear, or a helical gear.

11. The gear of claim 1, wherein the gear is configured to mate with a mating gear, and wherein the gear and the mating gear are components of one of a linear gear system, a helical gear system, a hypoid gear system, a worm gear system, a bevel gear system, a herringbone gear system, a double helical gear system, or a spur gear system.

12. The gear of claim 1, further comprising a compliant tooth comprising two compliant members of the plurality of compliant members, and wherein:
the compliant tooth comprises a first compliant member comprising a first distal compliant portion bending inward toward a center of the compliant tooth; and
the compliant tooth comprises a second compliant member comprising a second distal compliant portion bending inward toward the center of the compliant tooth.

13. The gear of claim 12, wherein:
the first compliant member comprises an involute curvature forming the bend inward toward the center of the compliant tooth; and
the second compliant member comprises an involute curvature forming the bend inward toward the center of the compliant tooth.

14. The gear of claim 1, wherein the gear is fabricated as a single element using additive manufacturing techniques.

15. The gear of claim 14, wherein the gear is fabricated using the additive manufacturing techniques such that fabrication does not comprise any joining process for joining separate components.

16. The gear of claim 14, wherein the gear is fabricating using metal additive manufacturing techniques or plastic additive manufacturing techniques.

17. The gear of claim 1, wherein the gear is fabricated using wire Electric Discharge Machining (EDM) techniques.

18. The gear of claim 1, wherein a length and elasticity of the plurality of compliant members is optimized to reduce or eliminate backlash between the gear and a mating gear.

19. The gear of claim 1, wherein the gear is implemented in a mechanically scanning antenna array to precisely alter a directional orientation of the electronically scanning antenna array.

20. The gear of claim 1, wherein the gear further comprises a central hub comprising a central hole disposed therethrough, wherein the central hole is configured to receive a shaft that drives rotation of the gear, and wherein the gear and the shaft are components of an antenna assembly.

21. The gear of claim 1, wherein two or more of the plurality of compliant members interface with a mating tooth of a mating gear during operation, and wherein the two or more of the plurality of compliant members form an interference fit with the mating tooth of the mating gear.

22. The gear of claim 1, wherein each of the plurality of compliant members comprises an involute curve.

23. The gear of claim 1, wherein each of the plurality of compliant members is fabricated of a material capable of deforming when exposed to an outside force and then returning to an equilibrium state when the outside force is removed.

24. The gear of claim 1, wherein the gear is configured to mate with a linear gear.
